(19) United States
(12) Patent Application Publication
(10) Pub. No.: US 2006/0266913 A1
(43) Pub. Date: Nov. 30, 2006

(54) System, method, and apparatus for nodal vibration analysis of a device at different operational frequencies

(75) Inventors: Robert McCoy, Talala, OK (US); Gordon Besser, Claremore, OK (US)

Correspondence Address: BRACEWELL & GIULIANI LLP, P.O. Box 61389, HOUSTON, TX, 77208-1389, US

(73) Assignee: BAKER HUGHES INCORORATED

(21) Appl. No.: 11/137,884

(22) Filed: May 26, 2005

(51) Int. Cl. F16M 13/00

(52) U.S. Cl. 248/550

(57) ABSTRACT

The speed of a motor is varied in an electrical submersible pump well to analyze and avoid excessive vibration. A vibration sensor near the motor senses vibration in the well. The vibration of the assembly varies with many factors, including the length of the tubing, the locations of the packers, and the use of centralizers relative to the casing. The assembly has critical frequencies at which vibration increases to an undesirable level. These critical frequencies are determined and programmed into the variable speed drive so that they may be avoided. Avoidance of the critical vibration frequencies prolong the life of the downhole equipment, including that of the motors, pumps, seals, and sensors.

### BACKGROUND OF THE INVENTION

1. Technical Field

The present invention relates in general to vibration analysis and, in particular, to an improved system, method, and apparatus for analyzing and avoiding excessive vibration in a variable frequency device, such as an electrical submersible pump.

2. Description of the Related Art

Electrical submersible pumps (hereinafter referred to “ESPs”) are commonly used in oil and gas wells for producing large volumes of well fluid. An ESP typically has a centrifugal pump with a large number of stages of impellers and diffusers. Other types of pumps include progressive cavity or positive displacement pumps (PCP) and rod drive PCPs where the motor is at the surface. In most cases, the pump is driven by a downhole motor, which is usually a large, three-phase AC motor. A seal section separates the motor from the pump for equalizing internal pressure of lubricant within the motor to that of the well bore. Additional components are often included such as a gas separator, a sand separator, and a pressure and temperature measuring module. Large ESP assemblies may exceed 100 feet in length.

An ESP is normally installed in a well by securing it to a string of production tubing and lowering the ESP assembly into the well. Production tubing is made up of sections of pipe, each being about 30 feet in length. The components of the ESP are installed within the well casing and connected to the tubing which extends to the surface of the well. All of the downhole components are suspended from the wellhead to effectively create a long resonance tuning system. The resonances are changed according to where the string of tubing and equipment touch the well casing. For example, a packer may interconnect to the casing, or centralizers may be utilized along the string. In these types of cases, the resonances or nodal vibration frequencies and magnitudes change, but can still remain a problem within the ESP system. These nodal vibrations cause excessive wear in bearings, seals, and other equipment that results in a shortened run life for the ESP system. Thus, a solution for overcoming these vibration problems would be desirable.

### SUMMARY OF THE INVENTION

One embodiment of a system, method, and apparatus for analyzing and avoiding excessive vibration in a device at different operational frequencies is disclosed. For example, in a variable frequency drive such as an electrical submersible pump (ESP) assembly string, the speed of the motor can be varied in the well. A vibration sensor mounted to the string senses the vibrations in the well. The vibration sensor may be located below the motor.

The harmful (e.g., resonant) frequencies of the overall assembly varies depending on the length of the tubing, the locations of the packers, and the use of centralizers relative to the casing. The assembly has certain “critical” frequencies or areas of operation at which vibration increases to an undesirable level. These critical frequencies are determined and programmed into the drive so that they may be avoided. Avoidance of the critical vibration frequencies beneficially prolong the life of the downhole equipment, including that of the motors, pumps, seals, and sensors.

In one embodiment, the entire range of operational frequencies are automatically sampled or swept through over a short time span (e.g., approximately 20 seconds) to avoid prolonged exposure to the undesirable resonances. On older drives, this sweep may be performed manually. This process also may be repeated to confirm the resonant frequencies. The vibration amplitude at each frequency is detected and recorded. The troublesome frequencies are then programmed into the system so that the system avoids operation at those frequencies. The present invention may be implemented as a start-up sequence for each installation. In addition, this operation may be performed at temporary installations (e.g., to determine well performance) by sweeping through different frequencies for equipment that runs at fixed speeds.

In one embodiment of the present invention, all of the frequencies of an installed ESP assembly are sampled through the use of a variable speed motor drive while monitoring the magnitude of vibration from a sensor located near the ESP motor. Any potentially troublesome frequencies are then entered either manually or automatically into the drive programming as frequencies to avoid during operation.

Alternatively, processing or analyzing an ESP system with the present invention may reveal that an inappropriate configuration was installed and that a different configuration or installation is needed to reduce vibration in order to improve run life. In another alternate embodiment, the vibration sensor may be sampled more often and provide a frequency domain response to the controller. This version provides additional operational information as to the precise frequency component causing the undesirable vibration.

The foregoing and other objects and advantages of the present invention will be apparent to those skilled in the art, in view of the following detailed description of the present invention, taken in conjunction with the appended claims and the accompanying drawings.

### BRIEF DESCRIPTION OF THE DRAWINGS

So that the manner in which the features and advantages of the invention, as well as others which will become apparent are attained and can be understood in more detail, more particular description of the invention briefly summarized above may be had by reference to the embodiment thereof which is illustrated in the appended drawings, which drawings form a part of this specification. It is to be noted, however, that the drawings illustrate only an embodiment of the invention and therefore are not to be considered limiting of its scope as the invention may admit to other equally effective embodiments.

FIG. 1 is a sectional view of one embodiment of a submersible pump assembly in a well and is constructed in accordance with the present invention; and

FIG. 2 is a high level flow diagram of one embodiment of method constructed in accordance with the present invention.

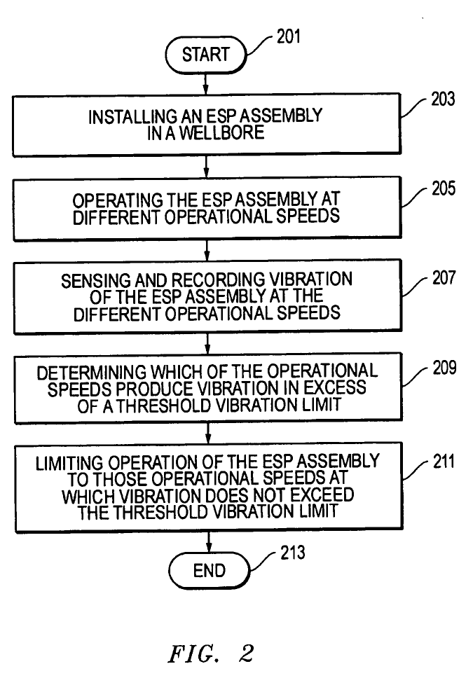

### DETAILED DESCRIPTION OF THE INVENTION

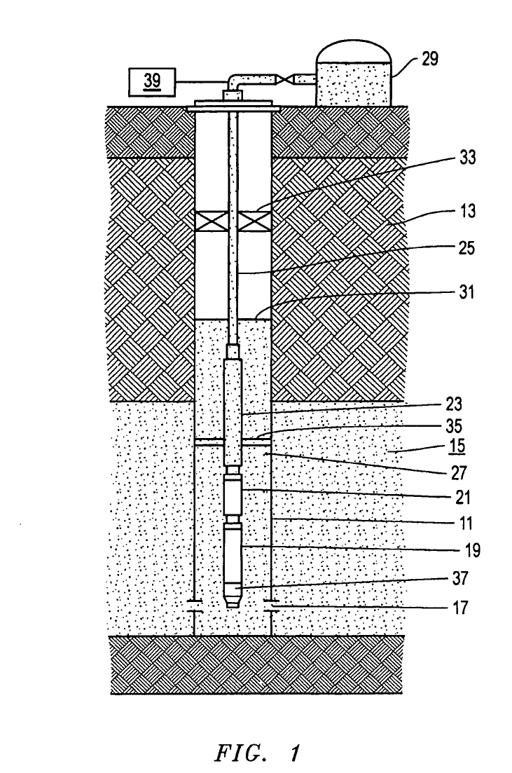

Referring to FIG. 1, well casing 11 is located within a well in earth formation 13 and also passes through a producing zone 15. Perforations 17 formed in the well casing 11 enable the fluid in the producing zone 15 to enter the casing 11. A pump assembly (e.g., an electrical submersible pump, or ESP) includes an electrical motor 19 that, in one embodiment, is located on a string in the well. The shaft of motor 19 extends through a seal section 21 and is connected to a centrifugal pump 23. Pump 23 is connected to tubing 25 for conveying well fluid 27 to a storage tank 29 at the surface. The casing 11 contains wellbore fluid 27 at an operating fluid level 31 in the annulus of the casing 11. One or more packers 33 and/or centralizers 35 may be located in the string as well. The string also includes a vibration sensor 37 and a controller 39 for cycling and programming the equipment in the string and recording information therefrom.

In one embodiment, the present invention comprises a system for analyzing and avoiding excessive vibration of a device. The system may comprise, for example, an electrical submersible pump (ESP) assembly mounted to a string in a well and having a variable frequency motor 19. A vibration sensor 37 is mounted to the string for sensing vibrations and/or oscillations of the ESP assembly in the well. The system also comprises a controller 39 for operating the ESP assembly in a range of operational frequencies.

The controller 39 utilized by the ESP assembly is a motor drive system that controls the frequency to the motor. As the frequency is varied, the rotational speed of the motor varies to pump different amounts of liquid to the surface. Controller 39 may be computer-based and allow for intelligent operation of the well system. The frequency can be swept either on start-up or periodically to examine the installation for resonances. The computing ability of the drive allows for programmable logic control (PLC) functions to be performed and provide the avoidance of certain critical resonant frequencies. The PLC functionalities allow for over variables to override this control if needed for safetyu or normal operation.

In one embodiment, the controller 39 records, via the vibration sensor 37, specific frequencies at which vibration amplitude in the ESP assembly exceeds an undesirable threshold. The controller then limits operation of the ESP assembly to those frequencies that do not exceed the undesirable threshold. In this way, the controller may be programmed to avoid vibration amplitude above the undesirable threshold.

In one version, an entire range of operational frequencies of the ESP assembly are automatically sampled in a time span of approximately 20 seconds to avoid prolonged exposure to vibration at or above the undesirable threshold. The range of operation frequencies also may be manually sampled at fixed operational speeds. Operation over the range of operational frequencies may be repeated to confirm the frequencies at which the undesirable threshold is exceeded.

Moreover, the controller may process the ESP system to reveal that an inappropriate configuration was installed and that a different configuration is needed to reduce vibration in order to improve run life of the ESP system. Furthermore, the controller may frequently sample the vibration sensor to provide a frequency domain response such that additional operational information as to an individual component in the ESP assembly causing the undesirable vibration is detected.

The sample rate can be high enough to provide detailed information concerning the rotational stability of the ESP system. This may include samples at approximately 1 ms each over several seconds, which are then converted to time domain (FFT), e.g., either downhole for transmission compression or in the surface processors. Items such as bearing wear, unbalance of stages, and other stresses and wear of the system can be detected and resonance frequencies can be detected and avoided.

The present invention also comprises a method of analyzing and avoiding excessive vibration in, for example, a well. In one embodiment, the method begins as indicated at step 201, and comprises installing an ESP assembly in a wellbore (step 203); operating the ESP assembly at different frequencies or operational speeds (step 205); sensing and recording vibration of the ESP assembly at the different frequencies or operational speeds (step 207); determining which of the frequencies or operational speeds produce vibration in excess of a threshold vibration limit (step 209); limiting operation of the ESP assembly to those frequencies or operational speeds at which vibration does not exceed the threshold vibration limit (step 211); before ending as indicated at step 213.

The method may comprise operating the ESP assembly with a variable frequency drive or a fixed speed drive. The method also may comprise automatically sweeping through a complete range of the different frequencies in approximately 20 seconds, or manually sweeping through the different frequencies at fixed operational speeds. In addition, the method may comprise programming the ESP assembly to avoid the frequencies that produce vibration in excess of the threshold vibration limit, or repeating the previous cited steps to confirm unacceptable frequencies.

Moreover, the method may further comprise determining that a different installation for the ESP assembly is needed to reduce vibration. Furthermore, the method may further comprise increasing a sampling of vibration detection over different frequencies and providing a frequency domain response to ascertain a particular component of the ESP assembly causing the undesirable vibration.

While the invention has been shown or described in only some of its forms, it should be apparent to those skilled in the art that it is not so limited, but is susceptible to various changes without departing from the scope of the invention. For example, the ESP may utilize a centrifugal pump, a progressive cavity pump (PCP), a positive displacement pump, or a rod drive PCP where the motor is at a surface of the well.

What is claimed is:

1. A system for analyzing and avoiding excessive vibration of a device, the system comprising:
a pump assembly mounted to a string in a well, the pump assembly being driven by a motor that is operable at different frequencies;
a vibration sensor mounted to the string for sensing vibrations of the pump assembly in the well; and
a controller for operating the pump assembly in a range of operational frequencies, the controller also recording, via the vibration sensor, specific frequencies at which vibration amplitude in the pump assembly exceeds an undesirable threshold, and the controller limiting operation of the pump assembly to those frequencies that do not exceed the undesirable threshold.

2. A system according to claim 1, wherein the motor is a downhole motor and the vibration sensor is located below the downhole motor.

3. A system according to claim 1, further comprising a packer mounted to the string.

4. A system according to claim 1, further comprising programming the controller to avoid vibration amplitude above the undesirable threshold.

5. A system according to claim 1, wherein an entire range of operational frequencies of the pump assembly are automatically sampled in a limited time span to avoid prolonged exposure to vibration at or above the undesirable threshold.

6. A system according to claim 1, wherein the range of operational frequencies are manually sampled at fixed operational speeds.

7. A system according to claim 1, wherein operation over the range of operational frequencies is repeated to confirm the frequencies at which the undesirable threshold is exceeded.

8. A system according to claim 1, wherein the controller analyzes the pump system to determine whether an inappropriate configuration was installed and whether a different configuration is needed to reduce vibration in order to improve run life of the pump system.

9. A system according to claim 1, wherein the controller frequently samples the vibration sensor to provide a frequency domain response such that additional operational information as to an individual component in the pump assembly causing undesirable vibration is detected.

10. A system according to claim 1, wherein a pump in the pump assembly is selected from the group consisting of an electrical submersible pump (ESP), a centrifugal pump, a progressive cavity pump (PCP), a positive displacement pump, and a rod drive PCP where the motor is at a surface of the well.

11. A system according to claim 1, further comprising a centralizer mounted to the string.

12. A method of analyzing and avoiding excessive vibration in a well, the method comprising:
(a) installing a pump assembly;
(b) operating the pump assembly at different operational speeds;
(c) sensing and recording vibration of the pump assembly at the different operational speeds;
(d) determining which of the operational speeds produce vibration in excess of a threshold vibration limit; and then
(e) limiting operation of the pump assembly to those operational speeds at which vibration does not exceed the threshold vibration limit.

13. A method according to claim 12, further comprising operating the pump assembly with a variable frequency drive.

14. A method according to claim 12, wherein step (b) comprises automatically sweeping through a complete range of different frequencies.

15. A method according to claim 12, wherein step (b) comprises manually stepping through different operational speeds.

16. A method according to claim 12, wherein step (e) comprises programming the pump assembly to avoid operational speeds that produce vibration in excess of the threshold vibration limit.

17. A method according to claim 12, further comprising repeating steps (b) through (d) to confirm unacceptable operational speeds.

18. A method according to claim 12, further comprising determining that a different installation for the pump assembly is needed to reduce vibration.

19. A method according to claim 12, further comprising increasing a sampling of vibration detection over different operational speeds and providing an operational speed domain response to determine if a particular component of the pump assembly is causing the undesirable vibration.

20. A method according to claim 12, further comprising operating the pump assembly with a pump selected from the group consisting of an electrical submersible pump (ESP), a centrifugal pump, a progressive cavity pump (PCP), a positive displacement pump, and a rod drive PCP where a motor is at a surface of the well.
